(19) United States
(12) Patent Application Publication
(10) Pub. No.: US 2008/0043114 A1
(43) Pub. Date: Feb. 21, 2008

(54) Image display apparatus and method of supporting high quality image

(75) Inventors: Gee-young Sung, Daegu (KR); Heui-keun Choh, Seongnam-si (KR); Du-sik Park, Suwon-si (KR); Hyun-chul Song, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/889,447

(22) Filed: Aug. 13, 2007

(30) Foreign Application Priority Data
Aug. 21, 2006 (KR) 10-2006-0078872

(51) Int. Cl. H04N 5/235; G06K 9/20; G06K 9/40

(52) U.S. Cl. 348/221.1; 382/260; 382/274; 382/312; 348/E05.034

(57) ABSTRACT

An image display method and a device to secure high quality of image are provided. The image display apparatus includes a photo sensitive module having a plurality of sub sensing areas corresponding to a plurality of lens areas, an exposure control module to set exposure starting times of the sub sensing areas to be different from each other, an intermediate image to produce module interpolating a plurality of original images captured by the sub sensing areas to produce a plurality of intermediate images that correspond to the original images, and a final image to produce module rearranging the intermediate images according to the order of the original image to produce final images.

### CROSS-REFERENCE TO RELATED APPLICATIONS

This application claims priority from Korean Patent Application No. 10-2006-0078872 filed on Aug. 21, 2006 in the Korean Intellectual Property Office, the disclosure of which is incorporated herein by reference in its entirety.

### BACKGROUND OF THE INVENTION

1. Field of the Invention

The present invention relates to an image display method and apparatus, more particularly, to an image display method and apparatus which are capable of obtaining an high quality image.

2. Description of the Related Art

Portable digital apparatus equipped with a camera module such as a digital still camera, a camera phone, etc. are widely used. Generally, a camera module includes a lens and an image sensor. In this case, the lens condenses light reflected from an object and the image sensor senses the light condensed by the lens and converts the light into an electrical image signal. The image sensor is largely classified into a camera tube and a solid-state image sensor. Representative examples of the solid-state image sensors include a CCD (charge coupled device) and an MOS (metal oxide silicon).

The image quality of moving pictures captured by the camera module depends on a frame rate which indicates the number of frames per second. When the frame rate is high, it is possible to minutely represent the motions of the object to be captured.

However, since the related art camera module has a limited sensitivity of the image sensor, the obtaining a high FPS (frame per second) while capturing the moving pictures is limited. However, when the image sensor of the camera module is substituted by a high sensitive image sensor, even though the frame rate is high, the manufacturing cost increases.

As a technique to provide an improved image to a user, research about a wide dynamic range of back light compensation (hereinafter, referred to as WDR compensation) or a camera-shaking compensation are being studied. The WDR compensation is an improved back light compensation, and when using this technique, it is possible to obtain the same image quality as seen from naked eyes even when imaging in a light or dark place. According to the camera shaking compensation, even though the camera is moving while taking a picture, the obtained image is compensated to obtain an improved image quality.

However, in order to implement the WDR compensation or the hand-shaking preventing function, a plurality of the same images is needed. Therefore, a plurality of pictures needs to be captured. However, since the environmental conditions of imaging changes as time passes, even when the imaging is performed a plurality of times at high shutter speed, obtaining the exact same images is difficult.

### SUMMARY OF THE INVENTION

Additional aspects and/or advantages of the invention will be set forth in part in the description which follows and, in part, will be apparent from the description, or may be learned by practice of the invention.

An aspect of the present invention is to provide an image display method and device which is capable of performing continuous imaging at high speed without providing a high sensitivity sensor.

Another aspect of the present invention is to provide an image display method and device that can obtain a plurality of images having luminances are different from each other through only one imaging process.

Aspects of the present invention are not limited to those mentioned above, and other aspects of the present invention will be apparently understood by those skilled in the art through the following description.

According to an aspect of the present invention, there is provided an image display apparatus including a photo sensitive module having a plurality of sub sensing areas corresponding to a plurality of lens areas, an exposure control module to set exposure starting times of the sub sensing areas to be different from each other, an intermediate image producing module to interpolate a plurality of original images captured by the sub sensing areas to produce a plurality of intermediate images that correspond to the original images, and a final image to produce module rearranging the intermediate images according to the order of the original image to produce final images.

According to another aspect of the present invention, there is provided an image display method including setting exposure starting times of a plurality of sub sensing areas that correspond to a plurality of lens area to be different from each other, capturing a plurality of original images through the plurality of sub sensing areas, producing intermediate images corresponding to the original images by interpolating the plurality of captured original images, and producing final images by rearranging the intermediate images according to the acquired orders of the original images.

According to still another aspect of the present invention, there is provided an image display apparatus including a photo sensitive module having a plurality of sub sensing areas corresponding to a plurality of lens areas, an exposure control module to set exposure conditions of the sub sensing areas to be different from each other, an intermediate image producing module to interpolate a plurality of original images having different luminances simultaneously captured by the sub sensing areas to produce a plurality of intermediate images, and a final image to produce module producing final images on the basis of pixel information of pixels of the intermediate images

According to yet another aspect of the present invention, there is provided an image display method including setting exposure conditions of a plurality of sub sensing areas that correspond to a plurality of lens area to be different from each other, capturing a plurality of original images having different luminances through the plurality of sub sensing areas, producing intermediate images corresponding to the original images by interpolating the plurality of captured original images, and producing final images by rearranging the intermediate images on the basis of pixel information of pixels of the intermediate images.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects and advantages of the invention will become apparent and more readily appreciated from the following description of the embodiments, taken in conjunction with the accompanying drawings of which:

FIG. 1 is a block diagram showing a configuration of an image display apparatus according to an embodiment of the present invention;

FIG. 2 is a block diagram showing a configuration of a camera module shown in FIG. 1;

FIG. 3 is a perspective view showing the camera module shown in FIG. 2;

FIG. 4 is a cross-sectional view showing a unit pixel of a photo sensitive module shown in FIG. 2;

FIG. 5 is a diagram showing a state of electrical charges charged by a plurality of sensing areas having different exposure times;

FIG. 6 is a diagram showing a state of electrical charges charged by a plurality of sensing areas having different exposure times;

FIG. 7 is a block diagram showing an image processing module shown in FIG. 1;

FIG. 8A is a flow chart of a high speed imaging method performed by the image display apparatus of FIG. 1;

FIG. 8B is a diagram showing sequentially images obtained by the method of FIG. 8A;

FIG. 9A is a flow chart showing operations when an exposure time of each of the sub sensing area is controlled in the image display apparatus shown in FIG. 1;

FIG. 9B is a diagram showing sequentially images obtained by the method of FIG. 9A;

FIG. 10A is a flow chart showing operations when a gain of each of the sub sensing areas is controlled in the image display apparatus shown in FIG. 1; and

FIG. 10B is a diagram showing sequentially images obtained by the method of FIG. 10A.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which preferred embodiments of the invention are shown.

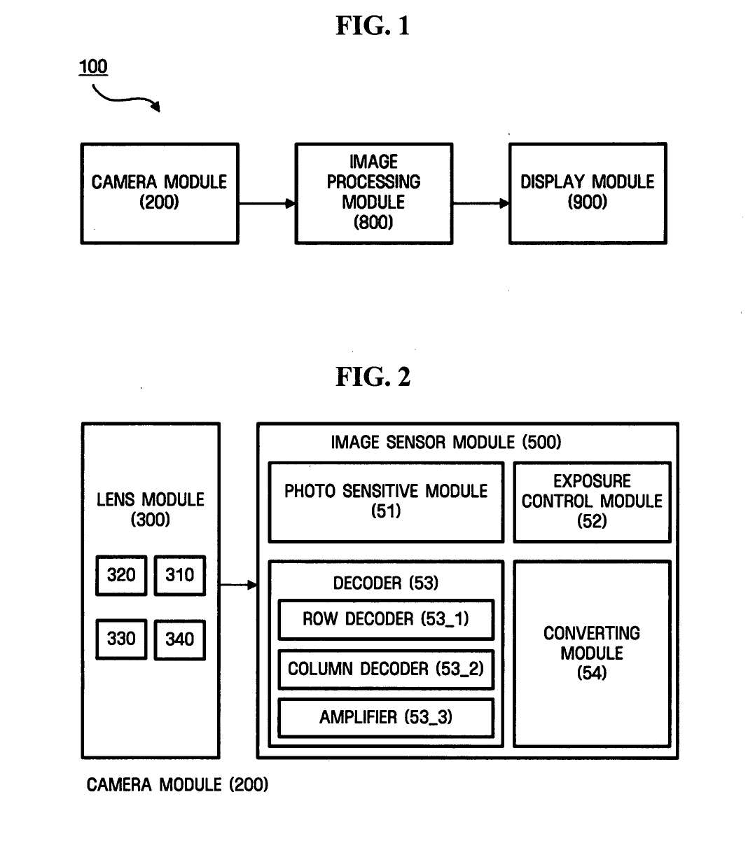

FIG. 1 is a block diagram showing a configuration of an image display apparatus 100 according to an embodiment of the present invention. The image display apparatus 100 includes a camera module 200 to condense incident light to produce a plurality of original images, an image processing module 800 to produce final images based on the plurality of original images produced by the camera module 200, and a display module 900 to display the final images produced by the image processing module 800.

The originals images produced by the camera module 200 may have same luminance or different luminances. The plurality of original images produced by the camera module 200 are supplied to the image processing module 800 which will be described later. The camera module 200 will be described in detail with reference to FIGS. 2 to 6.

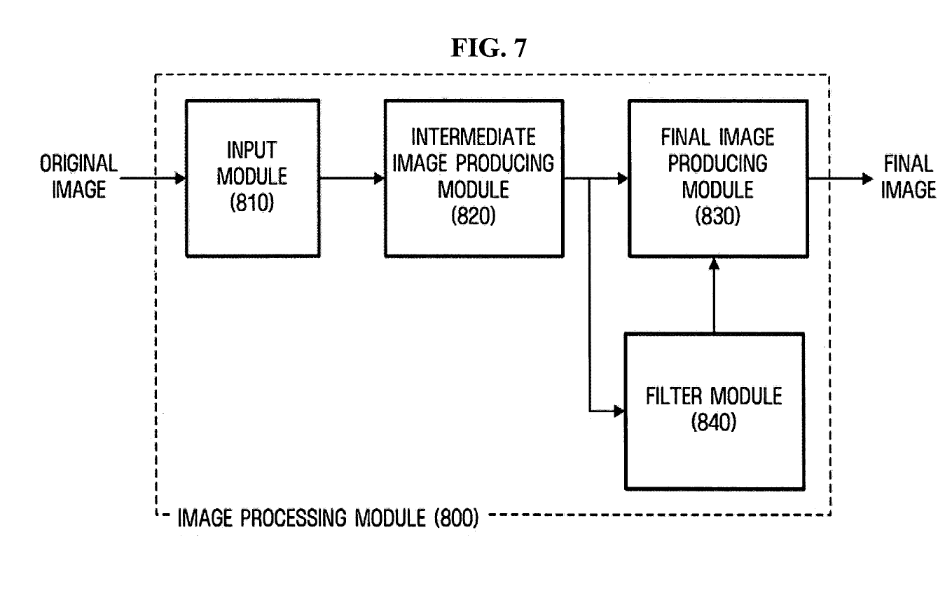

The image processing module 800 processes the plurality of original images supplied from the camera module 200 to produce final images. The image processing module 800 will be described in detail with reference to FIG. 7.

The display module 900 displays the final images produced by the image processing module 800. Even though such a display module 900 is embodied as a flat panel display or a touch screen, the display module 900 is not limited thereto.

FIG. 2 is a block diagram showing a configuration of the camera module 200 shown in FIG. 1. The camera module 200 includes a lens module 300 and an image sensor module 500.

The lens module 300 may include a plurality of lens 310, 320, 330, and 340 condensing incident light. However, the number of lenses is not limited, and the lenses are arranged on the same plane in various forms. For example, a plurality of lens 310, 320, 330, and 340 are arranged in one line in a vertical direction or a horizontal direction, or arranged in a matrix. Hereinafter, for convenience sake, it is described an example in which four lenses are arranged in 2×2 matrix.

The image sensor module 500 senses light condensed by the lenses to produce a plurality of original images. In order to perform the above operation, the image sensor module 500 includes a photo sensitive module 51, a decoder 53, a converting module 54, and an exposure control module 52.

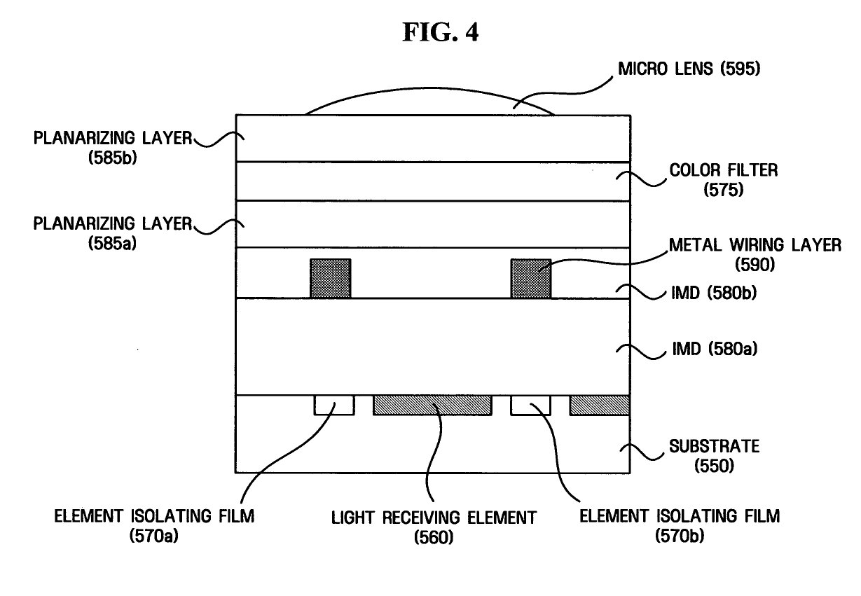

The photo sensitive module 51 senses light condensed by the lens module 300 to convert the light into an electrical signal and then convert the electrical signal into a voltage signal. The photo sensitive module 51 will be described in detail with reference to FIG. 4. FIG. 4 is a cross-sectional view of a unit pixel of the photo sensitive module 51.

Referring to FIG. 4, light receiving elements 560, for example, photo diodes are formed on a substrate 550. Element isolating films 570a and 570b are formed between the light receiving elements 560.

A metal wiring layer 590 is formed above the light receiving elements 560 to form a circuit. An IMD (inter-metal dielectric) 580a is formed between the light receiving elements 560 and the metal wiring layer 590. The metal wiring layer 590 may be formed so as not to block a path of light incident onto the light receiving elements 560. In FIG. 4, even though one of metal wiring layer 590 is formed, a plurality of metal wiring layers may be formed as necessary. In this case, another IMD 580b is formed in the metal wiring layers 590 to insulate the metal wiring layers.

A planarizing layer 585a and a color filter layer 575 are formed on the IMD 580b in this order. The color filter layer 575 includes a red color filter, a green color filter, and a blue color filter, and the individual color filters perform to filter on the light condensed by the plurality of lenses 310, 320, 330, and 340 to represent the original colors. Each of the color filters may be formed in various patterns, and an example that the red color filter, the green color filter, and the blue color filter are formed in a Bayer pattern will be described.

Above the color filter layer 575, a planarizing layer 585b planarizing the color filter layer and an ML (micro lens) 595 to increase the photo sensitivity of the light receiving element 560 are formed in this order. Generally, the light receiving element 560 does not occupy the entire region of the unit pixel, but occupies only a part of the unit pixel. Therefore, a fill factor that indicates an area of the pixel occupied by the light receiving element 560 is 1 or less, which indicates that a part of incident is lost. In contrast, when the micro lens 595 is formed on the uppermost portion of the IMD 589b, since the incident light is condensed by the micro lens 595, it is possible to increase the amount of light converged to the light receiving element 560.

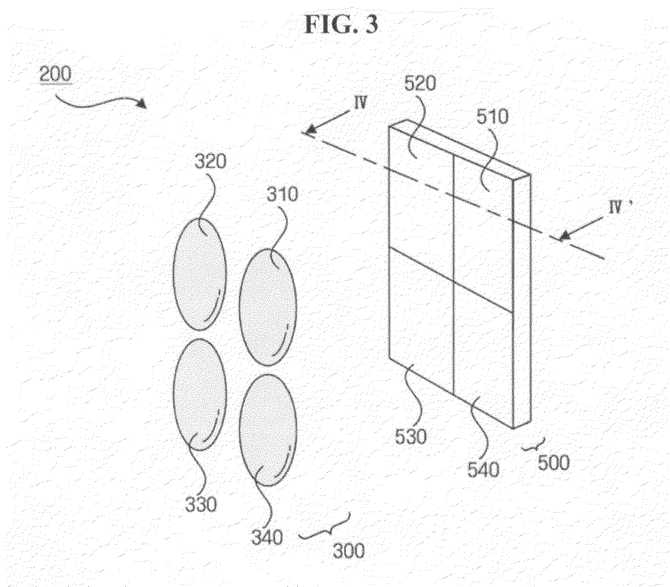

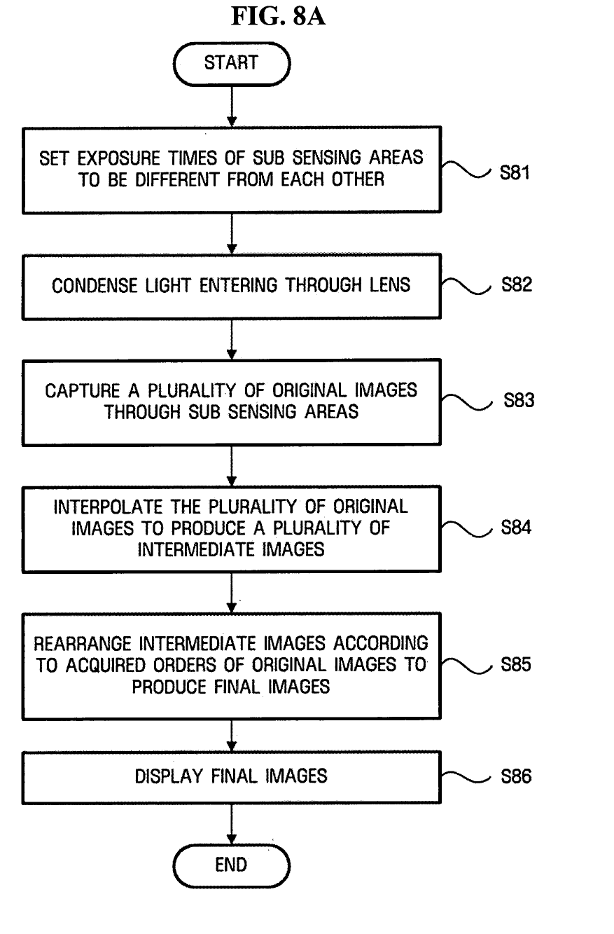

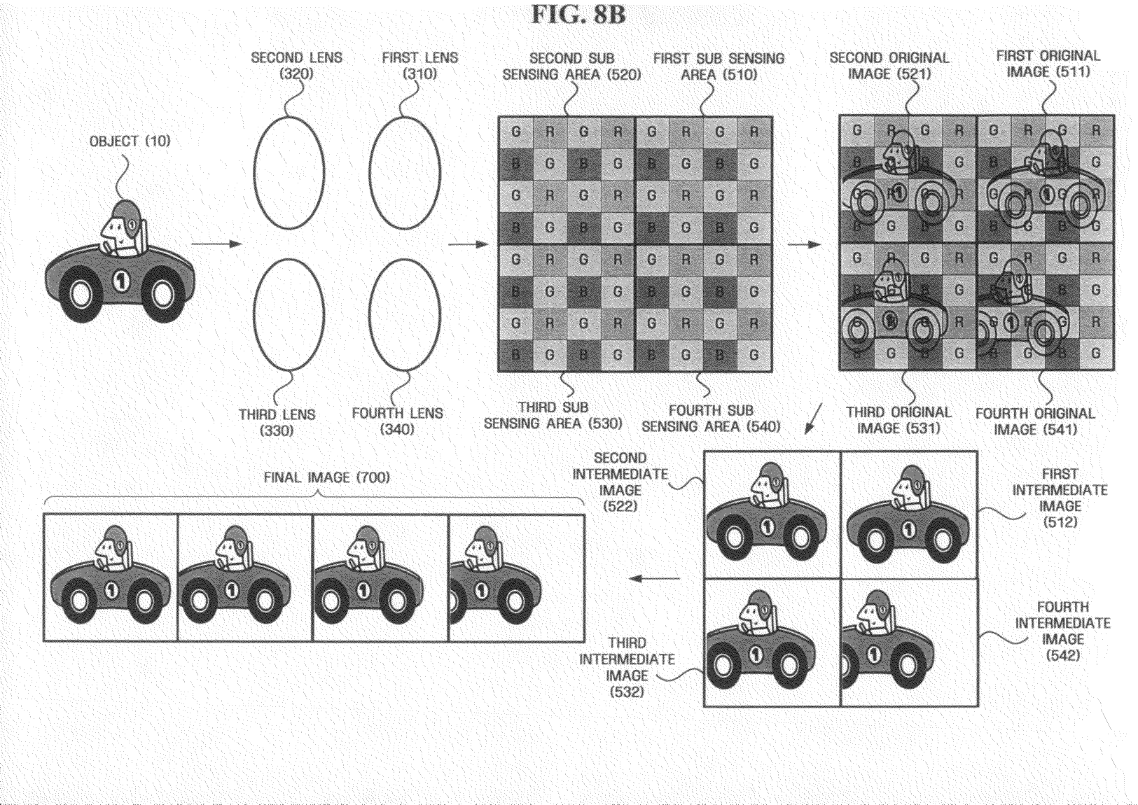

A plurality of the pixels configured as mentioned above form sensing area 510, 520, 530, and 540. In this case, the sensing area 510, 520, 530, and 540 is divided into plurality of sub sensing areas as shown in FIG. 3 so as to correspond to the plurality of lenses. That is, the first sub sensing area 510 corresponds to the first lens 310, the second sub sensing area 520 corresponds to the second lens 320, the third sub sensing area 530 corresponds to the third lens 330, and the fourth sub sensing area 540 corresponds to the fourth lens 340. In the following description, for convenience sake, it is assumed that the sensing area is formed of pixels formed in a 8×8 matrix (shown in FIG. 8B), and each of the sub sensing area that corresponds to each of the lenses is formed of pixels formed in a 4×4 matrix (shown in FIG. 8B).

The decoder 53 reads the voltage signal indicated by a pixel in a predetermined sub sensing area. For its sake, the decoder 53 includes a row decoder 53_1 to read information concerning pixels disposed in a horizontal direction, and a column decoder 53_2 to read information concerning pixels disposed in a vertical direction. Such a row decoder 53_1 and a column decoder 53_2 are provided for every sub sensing area, or assembled as a hardware. The voltage signals of the pixels are amplified by an amplifier 53_3 and then supplied to the converting module 54.

The converting module 54 converts the amplified voltage signal into a digital signal. The converting module 54 may be provided for every sub sensing area the same as the decoder, or may be assembled as a hardware.

The exposure control module 52 adjusts an exposure condition of each sub sensing area. Examples of exposure conditions include an exposure starting time, an exposure time, and a gain. The exposure time refers to a time when the sub sensing area is exposed to external light to accumulate electric charges. If the exposure times of the sub sensing areas are equal to each other, the same amount of electric charges is accumulated.

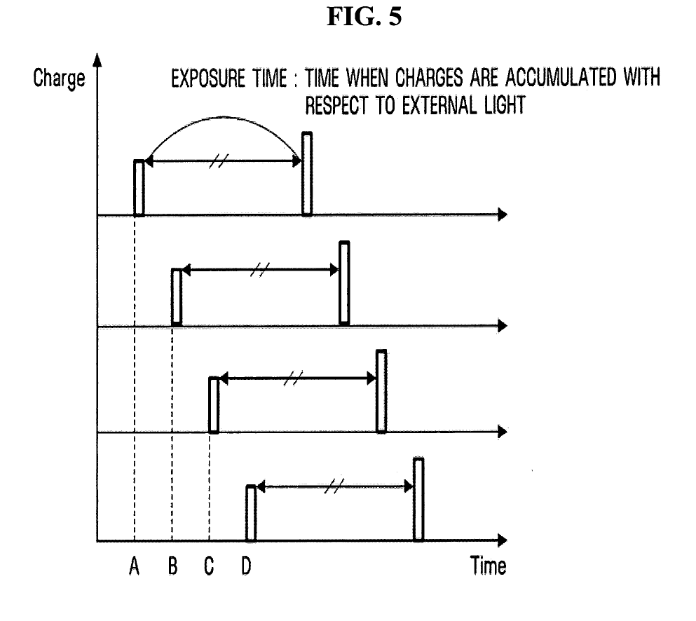

According to an exemplary embodiment of this invention, the exposure control module 52 sets such that the gains and the exposure times of sub sensing areas are equal to each other and the exposure starting times of the respective sub sensing area are different from each other. For example, as shown in FIG. 5, the first sub sensing area 510 is exposed for one second from a time point A, the second sub sensing area 520 is exposed for one second from a time point B, the third sub sensing area 530 is exposed for one second from a time point C, and the fourth sub sensing area 540 is exposed for one second from a time point D. Therefore, since different images can be captured from the respective sub sensing area 540, it is possible to increase the frame rate. Specifically, when six frames per second are captured by the sub sensing areas, if the images are captured in a state where the exposure starting times of the sub sensing areas are different from each other, the same effect as 24 frames per second are captured can be obtained. Further, since the frame rate becomes higher, the motion of the object is naturally represented.

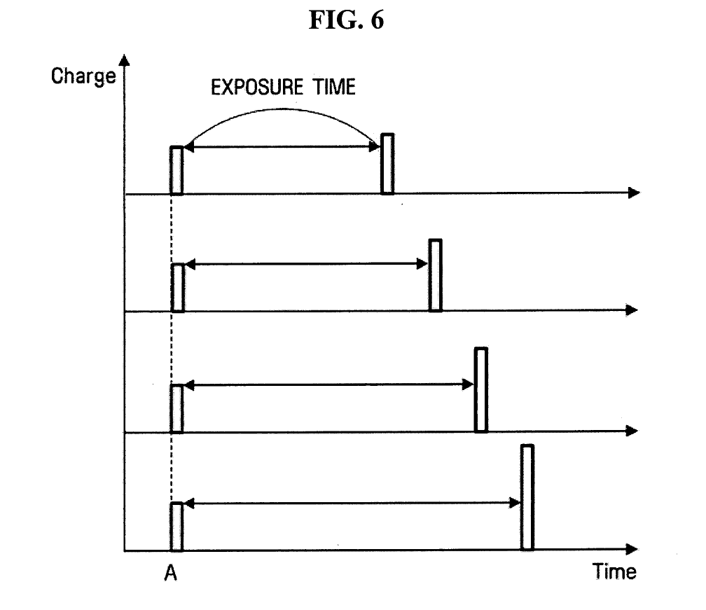

According to an embodiment of the present invention, the exposure control module 52 may set such that the exposure starting times are the equal to each other, but the exposure time of the sub sensing area are different from each other. For example, as shown in FIG. 6, the exposure starting time of all of the sub sensing areas is set to the time point A, and the exposure time of the first sub sensing area 510 is one second, the exposure time of the second sub sensing area 520 is two seconds, the exposure time of the third sub sensing area 530 is three seconds, and the exposure time of the fourth sub sensing area 540 is four seconds. With this configuration, it is possible to simultaneously obtain a plurality of images whose luminances are different from each other through one capturing process.

According to another example of the invention, the exposure control module 52 may set such that the exposure starting times and the exposure time of the sub sensing areas are equal to each other, and the gains are different from each other. As same as the example that the exposure times of the sub sensing areas are different from each other, in this example, it is possible to simultaneously obtain a plurality of images whose luminances are different from each other through one capturing process. Specifically, when a gain of a predetermined sub sensing area is controlled, the sensitivity of the corresponding sub sensing area increases in proposition to the gain. When the sensitivity of the sub sensing area is higher, more photons are emitted with the same intensity. Therefore, even though the other exposure conditions of each of the sub sensing areas are equal, when the gains are different from each other, the sensitivities of the sub sensing areas becomes different from each other. As a result, it is possible to simultaneously obtain a plurality of original images having different luminances due to the difference in the sensitivities of the sub sensing areas.

In addition to the above components, the image sensor module 500 may selectively include an infrared ray blocking filter (not shown) to block an infrared ray. The photo sensitive module 51 is sensitive to the infrared ray as well as a visible ray. Therefore, when using the infrared ray blocking filter, the infrared ray that reaches the photo sensitive module 51 is blocked, thereby preventing damage on information of images in the visible ray area.

Next, referring to FIG. 7, the image processing module 800 of FIG. 1 will be described.

FIG. 7 is a block diagram showing an image processing module 800 shown in FIG. 1. The image processing module 800 includes an input module 810, an intermediate image producing module 820, and final images producing module 830.

The plurality of original images from the camera module 200 is input to the input module 810. In detail, to the input module 810, the first original image obtained by the first sub sensing area 510, the second original image obtained by the second sub sensing area 520, the third original image obtained by the third sub sensing area 530, and the fourth original image obtained by the fourth sub sensing area 540 are input. The plurality of input original images functions to provide information concerning colors and luminances that are used to produce final images using the final images producing module 830 which will be described later.

The intermediate image producing module 820 performs a de-mosaic process on the plurality of input original images to produce a plurality of intermediate images. In here, the de-mosaic process refers a process that restores color information that is not included in a predetermined pixel using color information of the pixel and adjacent pixels.

The final images producing module 830 produces final images on the basis of the pixel information included in each of the pixels of the plurality of intermediate images. In this case, the pixel information may include color information, luminance information of a predetermined pixel.

The final images producing module 830 multiplies the pixel information of the pixel of each of the intermediate images by a predetermined weight. In this case, the predetermined weights that are multiplied to the pixel information may be the same, or varied depending on the luminances of the pixels. Thereafter, the final images producing module 830 produces final images on the basis of the pixel information of a pixel selected from pixels of the intermediate images that are disposed in the same position. For example, among the pixels of the intermediate images which are in the same position, the final images producing module 830 selects one pixel that has pixel information within a predetermined threshold value, and produces the final images on the basis of the pixel information of the selected pixel. Further, the final images producing module 830 may produce the final images on the basis of an average value of the pixel information of pixels of the intermediate images in the same position.

The image processing module 800 may further include a filter module 840. When the exposure control module 52 sets the gains of the sub sensing areas to be different from each other, a plurality of original images having different luminances can be obtained. However, the noise increases in proportion to the gain. Therefore, the noises are necessarily removed from the plurality of original images having different luminances. The filter module 840 removes the noises included in the plurality of original images by filtering the plurality of original images having different luminances. A higher weight may be applied to an original image that is obtained by a sub sensing area to which a higher gain is applied according to an aspect of the present invention.

Next, referring to FIGS. 8A and 8B, a high speed imaging method performed by the image display apparatus 100 shown in FIG. 1 will be described. FIG. 8A is a flow chart of a high speed imaging method performed by the image display apparatus 100 of FIG. 1 and FIG. 8B is a diagram showing sequentially images obtained by the method of FIG. 8A.

At first, the exposure control module 52 sets such that the gains and the exposure times of sub sensing areas are equal to each other and the exposure starting times of the respective sub sensing area are different from each other (S81). For example, the exposure control module 52 sets the exposure starting times of the sub sensing areas so that the first sub sensing area 510, the second sub sensing area 520, the third sub sensing area 530, and the fourth sub sensing area 540 are sequentially exposed in this order. Specifically, the exposure control module 52 sets the exposure starting time of the first sub sensing area 510 as A, the exposure starting time of the second sub sensing area 520 as B, the exposure starting time of the third sub sensing area 530 as C, and the exposure starting time of the fourth sub sensing area 540 as D, as shown in FIG. 5.

When taking a moving object 10 in this state, light reflected from the object 10 is condensed by four lenses 310, 320, 330, and 340 (S82).

The light condensed by the lenses 310, 320, 330, and 340 is converged into the corresponding sub sensing areas 510, 520, 530, and 540.

In this case, the sub sensing areas are sequentially exposed according to the previously set exposure starting times. That is, as shown in FIG. 5, the first sub sensing area 510, the second sub sensing area 520, the third sub sensing area 530, and the fourth sub sensing area 540 are sequentially exposed in this order.

Thereafter, the electrical signals generated by light converged into the sub sensing areas are converted into the voltage signals, and amplified, and converted into digital signals to output sequentially (S83). In this case, the resolution of an original images captured by a predetermined sub sensing area is 4×4, which is a quarter of a resolution of the sensing area 510, 520, 530, and 540. The plurality of original images 511, 512, 513, and 514 captured by the sub sensing areas are supplied to the image processing module 800.

The input module 810 of the image processing module 800 is supplied with the plurality of original images 511, 512, 513, and 514, and then supplies the original images to the intermediate image producing module 820.

The intermediate image producing module 820 interpolates the plurality of input original images 511, 521, 531, and 541 to produce a plurality of intermediate images 512, 522, 532, and 542 (S84).

When the plurality of intermediate images 512, 522, 532, and 542 are produced, the final images producing module 830 rearranges the plurality of intermediate images 512, 522, 532, and 542 according to the captured order of the original images 511, 521, 531, and 541 to produce final images 700 (S85).

The final images 700 produced by the final image producing module 830 are displayed on the display module 900 (S86). In this case, since the displayed final images 700 have a higher frame rate than that of the related art, it is possible to naturally represent the motion of the object 100. Specifically, when each of the sub sensing areas captures 6 images per second, the final images 700 can represents 24 images per second. Therefore, the motion of the object 100 can be more naturally represented as compared with the related art.

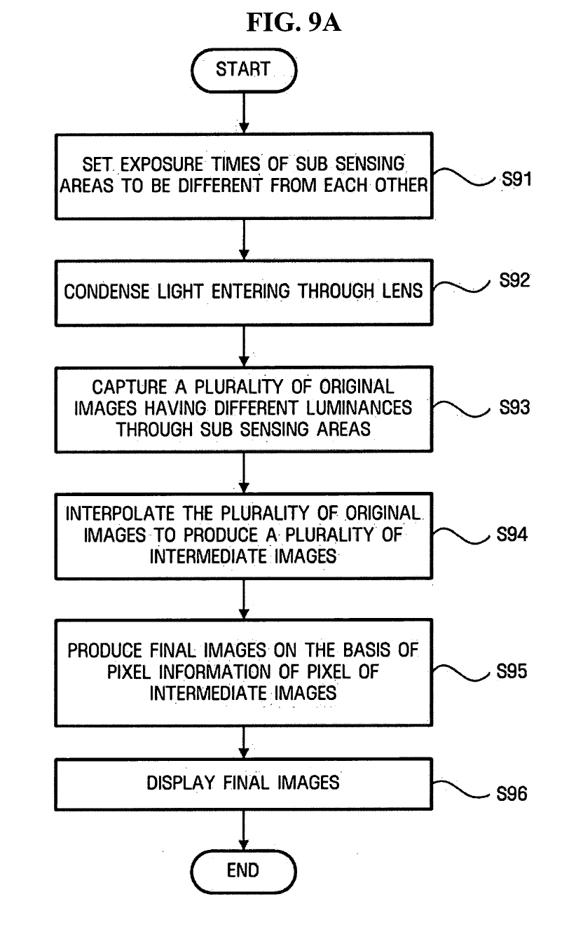

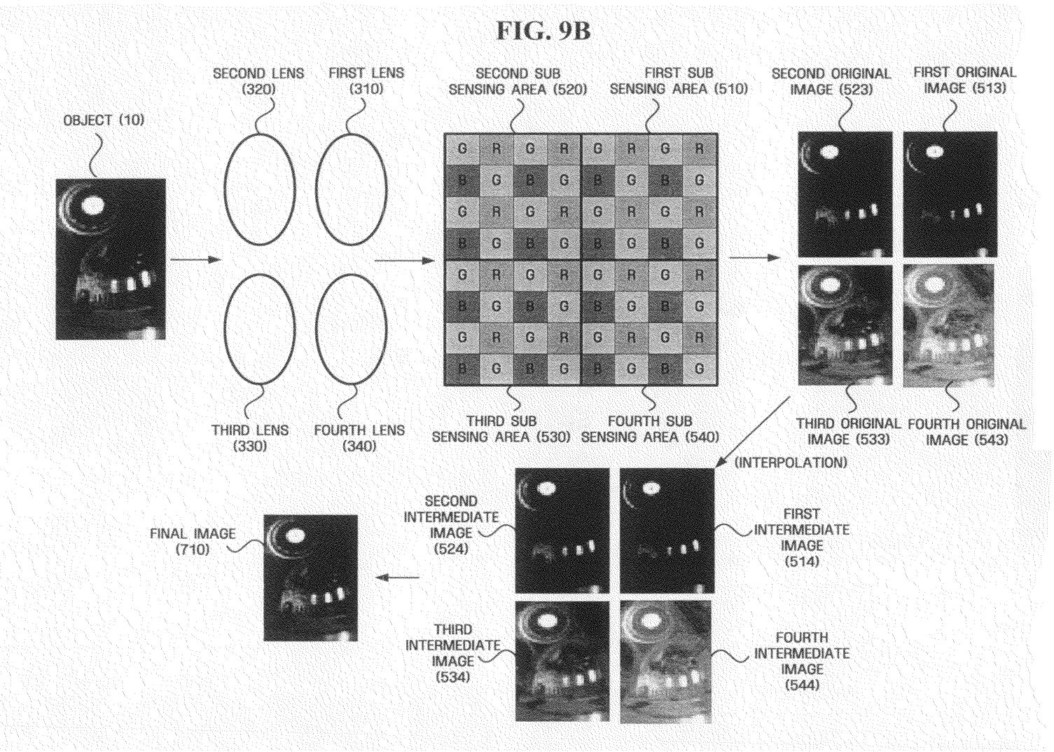

Next, referring to FIGS. 9A and 9B, a method of simultaneously capturing a plurality of images having different luminances by controlling the exposure time of each of the sub sensing areas. FIG. 9A is a flow chart showing a method of simultaneously capturing a plurality of images having different luminances by controlling the exposure time of each of the sub sensing area so as to be different from each other and FIG. 9B is a diagram showing sequentially images obtained by operations of FIG. 9A.

The exposure control module 52 sets the sub sensing areas such that the gains and the exposure starting times are equal to each other, and the exposure times are different from each other (S91). For example, as shown in FIG. 6, all of the gains of the sub sensing areas are set to 1, and all of the exposure time of the sub sensing areas are set to time A. The exposure times of the first sub sensing area 510, the second sub sensing area 520, the third sub sensing area 530, and the fourth sub sensing area 540 are one second, two seconds, three seconds, and four seconds, respectively.

When taking a picture in this state, light reflected from the object is condensed by four lenses (S92), and then converged into the corresponding sub sensing areas.

In this case, all of the sub sensing areas start to be simultaneously exposed at time A. Thereafter, the exposure of the first sub sensing area 510, the second sub sensing area 520, the third sub sensing area 530, and the fourth sub sensing area 540 is completed in this order. When the exposure of a predetermined sub sensing area is completed, the electrical signals generated by the light converged into the corresponding sub sensing area are converted into voltage signals, then amplified, and converted into digital signals to output sequentially (S93).

After the exposure of the fourth sub sensing area 540 is completed, when comparing the original images captured through the sub sensing areas with each other, it is known that the luminance becomes higher as the exposure time of the sub sensing area becomes longer. That is, the luminances become higher in the order of the first original image 513, the second original image 523, the third original image 533, and the fourth original image 543.

Therefore, when a plurality of original images 513, 523, 533, and 543 having different luminances are captured, the intermediate image producing module 820 de-mosaics the plurality of original images 513, 523, 533, and 543 having different luminances to produces a plurality of intermediate images 514, 524, 534, and 544 having different luminances (S94).

Thereafter, the final images producing module 830 produces final images on the basis of the pixel information included in each of the pixels of the plurality of intermediate images 514, 524, 534, and 544 having different luminances (S95).

The final images producing module 830 multiplies the pixel information of the pixel of each of the intermediate images 514, 524, 534, and 544 by a predetermined weight. In this case, the weights that are multiplied to the pixel information may be the same, or varied depending on the luminances of the pixels.

Thereafter, the final images producing module 830 produces final images 710 on the basis of the pixel information of a pixel selected from pixels of the intermediate images 514, 524, 534, and 544 that are disposed in the same position. For example, among the pixels of the intermediate images 514, 524, 534, and 544 that are in the same position, the final images producing module 830 selects one pixel that has pixel information within a predetermined threshold value, and produces the final images 710 on the basis of the pixel information of the selected pixel. Further, the final images producing module 830 may produce the final images 710 on the basis of an average value of the pixel information of pixels of the intermediate images 514, 524, 534, and 544 in the same position.

According to the above method, since it is possible to acquire a plurality of original images 513, 523, 533, and 543 by only one imaging process, it is possible to realize a clear image under a condition in which illuminance difference is large. That is, it is possible to realize WDR function.

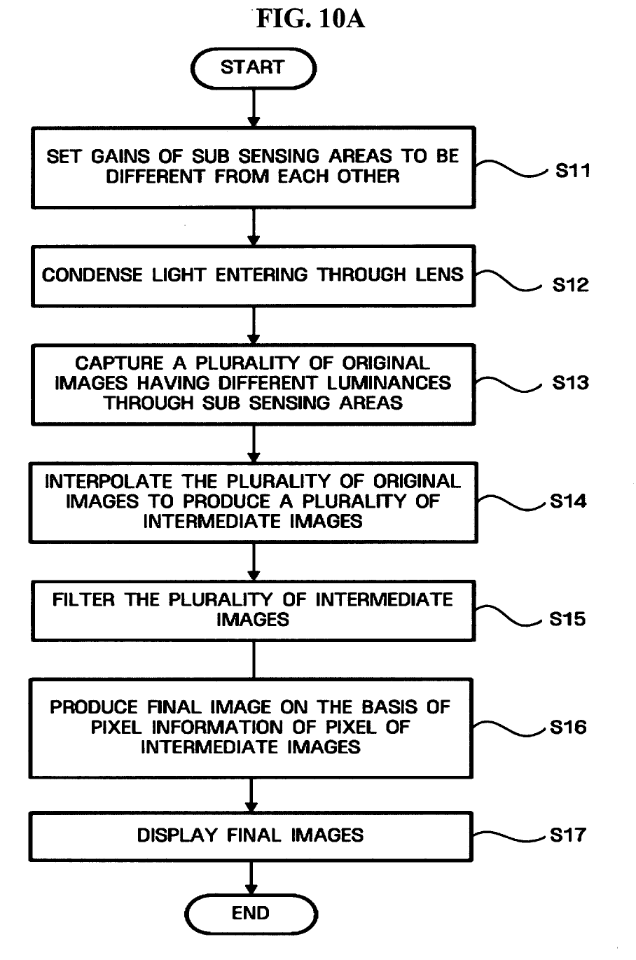

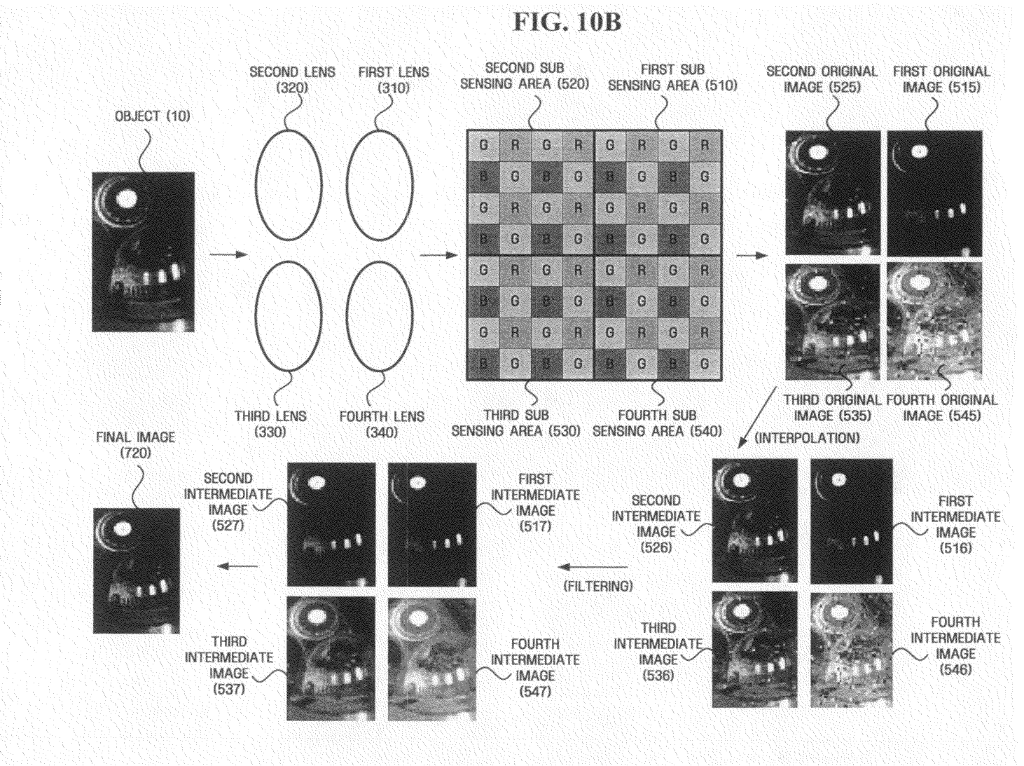

Next, referring to FIGS. 10A and 10B, a method of simultaneously capturing a plurality of images having different luminances by controlling the gain of each of the sub sensing areas.

FIG. 10A is a flow chart showing a method of simultaneously capturing a plurality of images having different luminances by controlling the gain of each of the sub sensing area so as to be different from each other and FIG. 10B is a diagram showing sequentially images obtained by operations of FIG. 10A.

The exposure control module 52 sets the exposure starting time and the exposure time of all of the sub sensing areas to be equal to each other. In this case, the exposure time is preferably set to a time that can prevent the motion blur due to the hand shaking of a user, for example 1/30 second or less.

The exposure control module 52 sets the sub sensing areas to have different gains (S11). For example, gains of the first sub sensing area 510, the second sub sensing area 520, the third sub sensing area 530, and the fourth sub sensing area 540 are 1, 2, 3, and 4, respectively.

When taking a picture in this state, light reflected from the object 10 is condensed by four lenses (S12), and then converged into the corresponding sub sensing areas. In detail, the light condensed by the first lens 310 is converged into the first sub sensing area 510, and the light condensed by the second lens 320 is converged into the second sub sensing area 520.

Thereafter, the sub sensing areas are simultaneously exposed for a predetermined time, for example, 1/30 second.

After the exposure of a predetermined sub sensing area is completed, the electrical signals generated by the light converged into the corresponding sub sensing area are converted into voltage signals, then amplified, and converted into digital signals to output. As a result, it is possible to obtain a plurality of original images having different luminances (S13).

Therefore, when comparing the original images captured through the sub sensing areas with each other, it is known that the luminance becomes higher as the exposure time of the sub sensing area becomes longer, as shown in FIG. 10B. That is, the luminances become higher in the order of the first original image 513, the second original image 523, the third original image 533, and the fourth original image 543. In detail, the luminance of the first original image 513 is the lowest, and the luminance of the fourth original image 543 is the highest. The sensitivity of the corresponding sub sensing area becomes higher as the gain of a predetermined sub sensing area becomes higher, it is because the amount of the emitted photons becomes higher with the same intensity.

The plurality of original images 515, 525, 535, and 545 having different luminances are captured (S13), the intermediate image producing module 820 interpolates the plurality of input original images 515, 525, 535, and 545 to produce a plurality of intermediate images 516, 526, 536, and 546 having different luminances.

Thereafter, the filter module 840 filters the plurality of intermediate images 516, 526, 536, and 546. In this case, filter module 840 preferably filters an intermediate image captured by a sub sensing area having high gain by applying a high weight. It is because the noises increases in proportion to the gain set in the corresponding sub sensing area.

Thereafter, the final image producing module 830 produces final images 720 on the basis of pixel information of each of the pixels of the plurality of filtered intermediate images 517, 527, 537 and 547. For this, the final images producing module 830 multiplies the pixel information of the pixel of each of the intermediate images 517, 527, 537 and 547 by a predetermined weight. In this case, the weights that are multiplied to the pixel information may be the same, or varied depending on the luminances of the pixels. Thereafter, the final images producing module 830 produces final images 720 on the basis of the pixel information of a pixel selected from pixels of the intermediate images 517, 527, 537 and 547 that are disposed in the same position. For example, among the pixels of the intermediate images 517, 527, 537 and 547 that are in the same position, the final images producing module 830 selects one pixel that has pixel information within a predetermined threshold value, and produces the final images 720 on the basis of the pixel information of the selected pixel. Further, the final images producing module 830 may produce the final images 720 on the basis of an average value of the pixel information of pixels of the intermediate images 517, 527, 537 and 547 in the same position.

According to the above method, it is possible to acquire a plurality of original images 515, 525, 535, and 545 by only one imaging process by controlling the gains of the sub sensing areas to be different from each other. As a result, it is possible to realize a clear image under a condition in which illuminance difference is large.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

According to the image display method and apparatus to obtain a high quality image, the following effects can be obtained.

First, since the high speed imaging can be performed with using the high sensitivity sensor, it is possible to obtain a high quality moving image.

Second, by controlling exposures conditions for a plurality of image sensing area, it is possible to simultaneously acquire a plurality of images having different luminance.

Third, since it is possible to simultaneously acquire a plurality of images having different luminance, it is possible to prevent the blurring or the false color during the image processing operations, and to realize the clear image under a condition in which illuminance difference is large.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image display apparatus comprising:
a photo sensitive module having a plurality of sub sensing areas corresponding to a plurality of lens areas;
an exposure control module setting exposure starting times of the sub sensing areas to be different from each other;
an intermediate image producing module interpolating a plurality of original images captured by the sub sensing areas to produce a plurality of intermediate images that correspond to the original images; and
a final image producing module rearranging the intermediate images according to the order of the original image to produce final images.

2. The apparatus of claim 1, wherein the exposure control module controls the sub sensing areas to have the same exposure time.

3. The apparatus of claim 1, further comprising a display module displaying the produced final images.

4. An image display apparatus comprising:
a photo sensitive module to have a plurality of sub sensing areas corresponding to a plurality of lens areas;
an exposure control module to set exposure conditions of the sub sensing areas to be different from each other;
an intermediate image to produce module interpolating a plurality of original images having different luminances captured by the sub sensing areas to produce a plurality of intermediate images; and
a final image producing module to produce final images on the basis of pixel information of pixels of the intermediate images.

5. The apparatus of claim 4, wherein the exposure conditions are one of an exposure starting time, an exposure time, and a gain of a predetermined sub sensing area.

6. The apparatus of claim 5, wherein the exposure control module sets the exposure starting times of the sub sensing areas to be different from each other.

7. The apparatus of claim 5, wherein the exposure control module sets the exposure starting times and exposure times of the sub sensing areas to be equal to each other and the gains of the sub sensing areas to be different from each other.

8. The apparatus of claim 7, further comprising a filter module to filter the plurality of original images, wherein the filter module applies different weights to the plurality of original images on the basis of the gains of the sub sensing areas.

9. The apparatus of claim 4, wherein the final image producing module produces the final images on the basis of pixel information of a pixel selected from pixels of the intermediate images that are disposed in the same position.

10. The apparatus of claim 9, wherein the final image producing module produces the final images on the basis of an average value of pixel information of the selected pixel.

11. The apparatus of claim 4, wherein weights that are applied to the pixel information are varied depending on the luminances of the pixels.

12. The apparatus of claim 1, wherein the image sensor module further comprises an infrared ray blocking filter to block an infrared ray.

13. An image display method comprising:
setting exposure starting times of a plurality of sub sensing areas that correspond to a plurality of lens area to be different from each other;
capturing a plurality of original images through the plurality of sub sensing areas;
producing intermediate images corresponding to the original images by interpolating the plurality of captured original images; and
producing final images by rearranging the intermediate images according to the acquired orders of the original images.

14. The method of claim 13, wherein the setting of the exposure starting times comprises setting the exposure times of the sub sensing areas to be equal to each other.

15. The method of claim 13, further comprising displaying the produced final images.

16. An image display method comprising:
setting exposure conditions of a plurality of sub sensing areas that correspond to a plurality of lens area to be different from each other;
capturing a plurality of original images having different luminances through the plurality of sub sensing areas;
producing intermediate images corresponding to the original images by interpolating the plurality of captured original images; and
producing final images by rearranging the intermediate images on the basis of pixel information of pixels of the intermediate images.

17. The method of claim 16, wherein the exposure conditions are one of an exposure starting time, an exposure time, and a gain of a predetermined sub sensing area.

18. The method of claim 17, wherein the setting of the exposure starting times comprises setting the exposure starting times of the sub sensing areas to be equal to each other and the exposure times of the sub sensing areas to be different from each other.

19. The method of claim 17, wherein the setting of the exposure starting times comprises setting the exposure starting times and exposure times of the sub sensing areas to be equal to each other and the gains of the sub sensing areas to be different from each other.

20. The method of claim 19, further comprising filtering the plurality of original images by applying different weights to the plurality of intermediate images on the basis of the gains of the sub sensing areas.

21. The method of claim 16, wherein the producing of final images comprises producing the final images on the basis of pixel information of a pixel selected from pixels of the intermediate images that are disposed in the same position.

22. The method of claim 21, wherein the producing of the final image comprises producing the final images on the basis of an average value of pixel information of the selected pixel.

23. The method of claim 16, wherein the producing of the final images comprises applying different weights to the pixel information on the basis of the luminances of the pixels.
